(19) United States
(12) Patent Application Publication
(10) Pub. No.: US 2013/0291433 A1
(43) Pub. Date: Nov. 7, 2013

(54) TREE WOUND GUARD AND METHOD FOR INSTALLATION THEREOF FOR A TREE SUPPORT CABLING SYSTEM

(71) Applicants: Clayton Geer, Lewisville, TX (US); Nathan W. Wright, Oak Point, TX (US); Jerrold Jakubos, Houston, TX (US); Scott Geer, Lewisville, TX (US)

(72) Inventors: Clayton Geer, Lewisville, TX (US); Nathan W. Wright, Oak Point, TX (US); Jerrold Jakubos, Houston, TX (US); Scott Geer, Lewisville, TX (US)

(21) Appl. No.: 13/864,432

(22) Filed: Apr. 17, 2013

Related U.S. Application Data
(60) Provisional application No. 61/642,374, filed on May 3, 2012.

(51) Int. Cl. A01G 13/00

(52) U.S. Cl. CPC A01G 13/0237
USPC 47/32.5

(57) ABSTRACT

The invention relates to a tree guard and an associated method for installation thereof for protecting cambium beneath the bark layer from mechanical damage caused by a tree support cabling system. The tree guard includes a cylindrical tube with a top wall and a bottom wall, a proximal end and a distal end sufficiently differentiated in length by a barrier ring rigidly attached on the top wall, such that the distal end be encircled and threaded through a hole at a first face of a trunk to reach a second face and the proximal end of the tube be remain out positioned about a circumference of the hole when the barrier ring anchors the tube against the trunk. The tube and the barrier ring having an inner diameter, and an outer diameter sufficiently larger to enable the cable to enter the tube and prevent the cable movement against the cambium, and not to inhibit growth of the tree respectively.

### CROSS REFERENCE TO RELATED APPLICATION

This application claims priority under 35 U.S.C. §119(e) to U.S. Provisional Patent Application Ser. No. 61642374, titled “Tree Wound Guard”, filed on May 3, 2012, the entire content of which is hereby incorporated by reference.

### FIELD OF THE INVENTION

The present invention relates generally to the area of arboriculture, and more particularly to a tree guard for protecting the cambium layer of a tree from damages caused by a tree support cable system.

### BACKGROUND OF THE INVENTION

Trees have a thin layer of cambium that lies just beneath the bark. The cambium layer is the meristematic tissue that produces new wood (xylem) and bark (phloem) tissue in a trees limbs and main stem. Damage to the cambium layer prevents the tree from healing a wound, such as a cable attachment point, and causes a tree to be more vulnerable to insect and disease problems.

Conventionally, in arboriculture, it is necessary to install cables to help support trees with structural defects or injury and to prevent their failure. In one conventional cabling system, as shown in FIG. 1, the arborists require the drilling of holes 10 through two adjacent trunks 14 of the tree, threading the ends of the cable 12 through each hole 10, and then putting a cable stop 16 on the end of the cable 12. In such cabling system, the cable 12 damages the exposed cambium layer of the trunk 14 leaving a wound W at the entrance points of the holes 10 when the tree is shaken. In such system, even though the tree attempts to heal the wound W with natural callous wood produced by the cambium layer, the constantly moving and rubbing cable 12 against the growing callous never allows the tree to heal this wound W. Such system where the tree is not able to heal the wounds W at the exposed entry point, the entry point acts as a point for decay which slowly develops structural instability in the tree leading to possible premature failure of the tree.

Typically tree guards are known to increase the survival rate of the trees by protecting the trunks from damage caused by insects or fungi etc., protecting the trees by moderating extreme temperatures or reflecting the sunlight, protecting the trees by reducing abrasion, and protecting the trees from small mammals. No prior art tree guards are known which would support and be used with various existing cabling systems in the arboriculture to enable the trees heal the wound caused by the cables entering the tree.

Accordingly, it is clear that there exists a long and unfulfilled need for a tree guard and an associated method for installation thereof which is less likely to impact adversely on the tree itself when used with conventional cabling systems and is not restrictive to choke off growth of callous when the guard is left unremoved, and that would provide adequate protection to the cambium layer of the tree.

Further, what is needed is a typical commercial tree guard illustrated in the accompanying figures which would easily fit into the holes drilled in the trunk of a given tree to prevent the cables passing therethrough rub against the exposed cambium layer at the entry point of the tree thereby preventing creation of the wound and help the tree heal the wound.

### OBJECTS AND SUMMARY OF THE INVENTION

Accordingly, it is an object of the present invention to provide a tree guard that would protect the cambium layer of tree from a cabling system conventionally used by arborists to support trees.

Another object of the present invention is to provide a tree guard that is generally threaded in the hole drilled in the tree to move the fulcrum of the cable's movement away from wound in the cambium layer of the tree.

The present invention aims at solving the problem mentioned above by providing a good operation efficient tree guard that would help the tree heal a wound naturally via callous wood produced by the cambium layer over time.

Another object of the present invention is to provide an inexpensive tree wound guard which is simple and economical to manufacture, and which can be serviced in a minimum time and can be quickly and easily applied.

Another object of the present invention is to address the disadvantages of the conventional cabling systems known to have achieved great commercial success, and overcome practical limitations associated with their direct use to support the trees in the field of arboriculture.

According to an aspect of the present invention, a tree guard for protecting cambium beneath the bark layer from mechanical damage caused by a tree support cabling system includes a cylindrical shape tube with a top wall and a bottom wall, the tube further includes a proximal end and a distal end sufficiently differentiated in length by a barrier ring rigidly attached on the top wall, such that the distal end be encircled and threaded through a hole at a first face of a trunk to reach a second face and such that the proximal end of the tube be remain out positioned about a circumference of the hole when the barrier ring anchors the tube against the trunk, wherein the tube having an inner diameter sufficiently larger than a cable diameter enables the cable to enter the tube and prevent cable movement against the cambium layer, and the barrier ring with an outer diameter sufficiently larger such as not to inhibit growth of the tree.

According to another aspect of the present invention, a method for installing a tree guard onto a trunk of a tree for protecting cambium beneath the bark layer from mechanical damage caused by a tree support cabling system, the guard includes a cylindrical shape tube with a top wall and a bottom wall, a proximal end and a distal end sufficiently differentiated in length by a barrier ring rigidly attached thereto on the top wall, the method includes preparing, a hole onto the trunk, the hole extending from a first face to a second face of the trunk, encircling and threading, the distal end of the tube through the hole at the first face to reach the second face, and allowing, the proximal end of the tube to remain out positioned about a circumference of the hole when the barrier ring anchors the tube against the trunk.

These and further objects, aspects of the invention will be obvious upon an understanding of the illustrative embodiment to be described or be indicated in the appended claims and various advantages not referred to herein will occur to one skilled in the art upon employment of the invention in practice.

### BRIEF DESCRIPTION OF THE DRAWINGS

The present invention will become more fully understood from the detailed description provided herein below and the accompanying drawings which are given by way of illustration only, and thus are not limitative of the present invention, and wherein:

FIG. 1 is a schematic perspective view showing a conventional tree support cabling system;

FIG. 2A-FIG. 2B is schematic perspective views showing tree support cabling systems commonly used in the arboriculture industry;

FIG. 3 is a perspective view showing how installed cabling system would look like without a tree guard of the present invention;

FIG. 4 is a perspective view illustrating the mounting of a tree guard according to an exemplary embodiment of the present invention;

FIG. 5 is a perspective view illustrating the mounting of a tree guard according to another exemplary embodiment of the present invention;

FIG. 6 is a perspective view illustrating the mounting of a tree guard according to another exemplary embodiment of the present invention; and

FIG. 7 illustrates a method for installing a tree guard onto a trunk of a tree, according to an embodiment of this present invention.

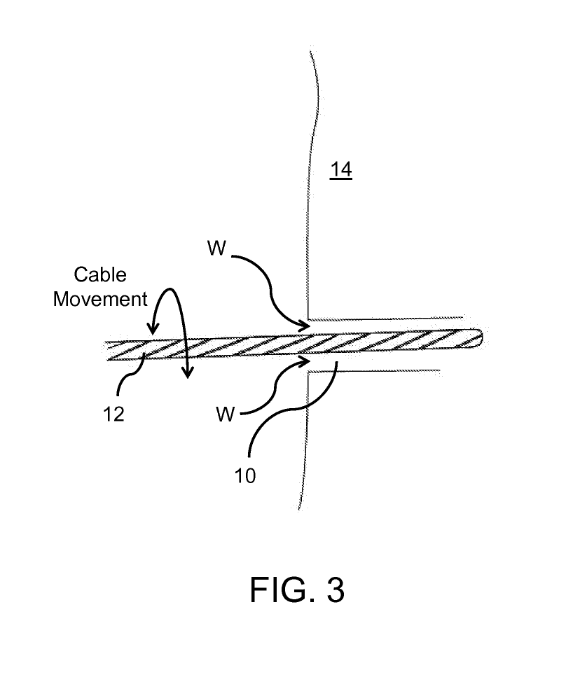

The figures above are shown slightly exploded in view—the guard is drawn slightly separated from the tree. In actual application, the guard is firmly pressed against the tree and there is no space between the guard and the tree. Further, in FIG. 3 through FIG. 6, only a section of trunk with just one face is shown illustrated for clarity and should not be considered as limiting.

### DETAILED DESCRIPTION OF THE PREFERRED EMBODIMENTS

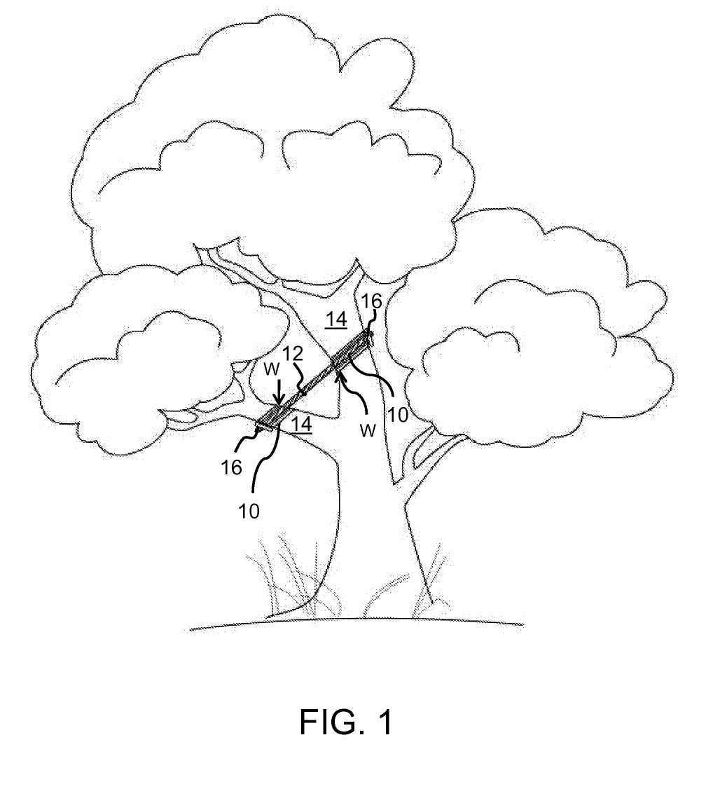

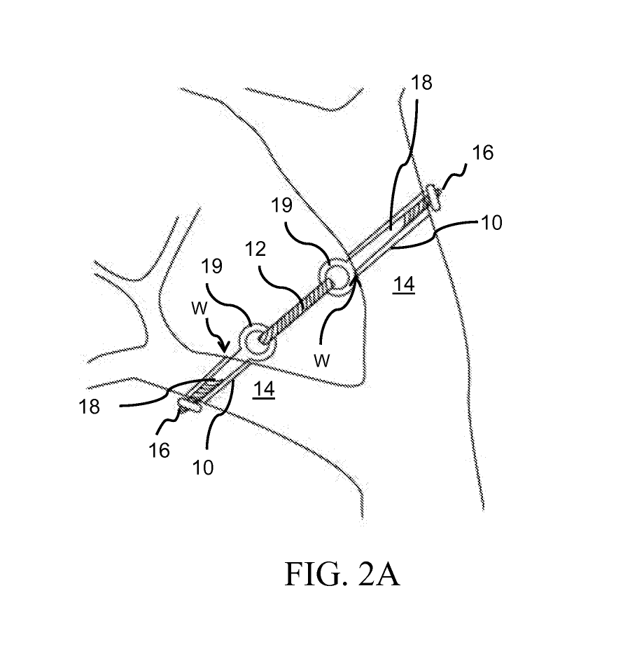

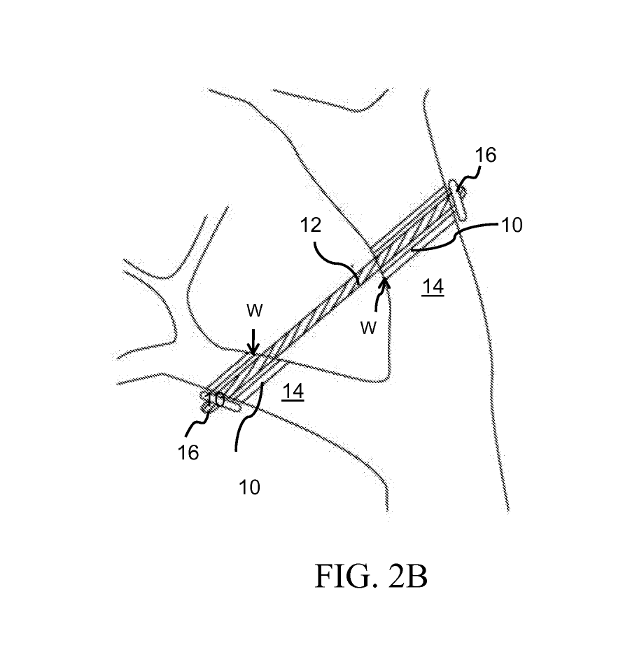

Referring now to the drawings and to FIG. 1 and FIGS. 2A-2B in particular, which shows schematic perspective views of conventional tree support cabling systems commonly used in the arboriculture industry. As seen, in FIG. 1 and FIG. 2B, a cable 12 is inserted through the holes 10 drilled onto the two trunks 14 and is anchored with some anchoring means 16 on either end. However, FIG. 2A shows conventional cable and bolt system where rods 18 are first inserted through the holes 10 drilled in the two trunks 14 and anchored at the ends and then the cable 12 is attached to each of eyelets 19 of each rod 18. All of these conventional cable support systems lead to increased stress on cambium layer of the tree when the tree moves which cause the cable 12 cut into the cambium creating wounds W.

As shown in FIG. 3, in conjunction to the conventional tree support cabling systems of FIG. 1 or FIG. 2B, the cable 12 is inserted directly through the hole 10 and is guided therethrough and is anchored with some anchoring means 16 on either end. Herein, when the tree is shaken by the wind or some other external force, the cable 12 rubs against the exposed cambium layer at the entry point about the hole 10 and creates the wound W. If the movement of the tree is frequent then the tree would be unable to heal off the wound W by natural callous wood produced by the cambium layer thereby causing decay to enter the tree.

Regardless of which embodiment of the tree support cabling system is included, the tree guard of the present invention can be used to prevent the cambium layer from the damage or the injury and help the cambium layer heal the wound W present at the entry point of the hole 10. The tree guard of the present invention may be made in different sizes with varying inner diameter and length in order to accommodate a broad range of cables 12 and trees. However, certain sizes are especially preferred like the guard designed for 0.1875-0.3375 inches cables 12. Preferred embodiment of the present tree guard has length of 4.5 inches with washers extending substantially through this entire length of 4.5 inches at regular intervals of 1.5 inches. But for those skilled in the art it should be apparent that the guard of any other suitable length be designed based on the maturity and width of tree trunks 14.

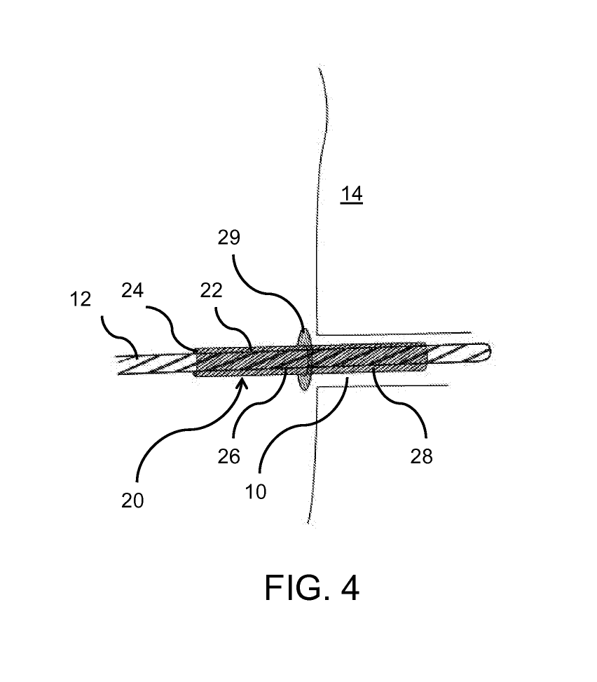

Referring now to FIGS. 4-6, and to FIG. 4 in particular that shows a preferred embodiment of the present invention. As shown mounted, the tree guard is adapted for protecting cambium beneath the bark layer from mechanical damage caused by the tree support cabling system and includes a cylindrical shape tube 20 with a top wall 22 and a bottom wall 24, a proximal end 26 and a distal end 28 differentiated in length by a barrier ring 29 rigidly mounted onto the top wall 22.

According to this embodiment, the distal end 28 of the tube 20 is encircled and threaded through the hole 10 drilled at a first face of the trunk 14 and pushed to reach the second face (not shown) of the trunk 14 to anchor the tube 20 at that end by suitable fastener or anchoring means 16. The proximal end 26 of the tube 20 remains out positioned about a circumference of the hole 10 when the barrier ring 29 anchors the tube 20 against the trunk 14. The tube 20 includes an inner diameter larger than a cable diameter. As a result, the cable 12 can enter the tube 20 easily and prevent cable 12 to move or rub against the exposed cambium layer. Further, the barrier ring 29 includes an outer diameter larger such as not to inhibit growth of the tree, preventing shifting of the tube 20 positioned in the hole 10 thereby controlling depth of insertion of the tube 20 inside the trunk 14. This mounting of the cable 12 through the tree guard of present invention is capable of moving the fulcrum of the cable's movement away from the cambium layer thereby preventing the damage of cambium layer.

According to the embodiment, the barrier ring 29 includes a diameter larger enough to provide an anchor to the tube 20 against the trunk 14, but small enough such as not to inhibit the tree growth. Preferably, but not by the way of any limitation, the barrier ring 29 with the outer diameter of 0.625 inches is ideal for a 0.25 inch cable assembly. However, it should be apparent to those skilled in the art that other similar cable 12 and the barrier ring 29 diameter ratios may be used as per the requirement.

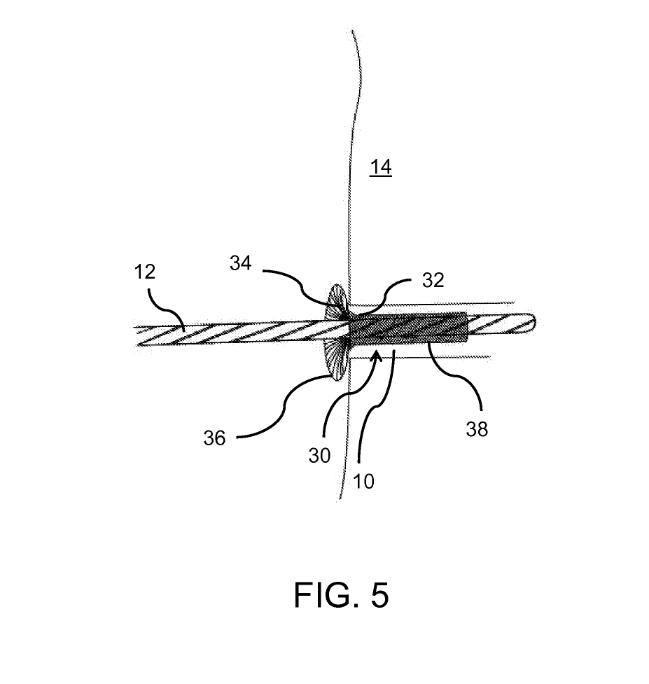

Referring to FIG. 5 illustrates the mounting of the tree guard according to another exemplary embodiment. As seen, the tree guard includes a funnel shape tube 30 with a top wall 32, a bottom wall 34, a funnel shape head 36 at first end and a cylindrical shape tube 38 at second end. According to this embodiment, the cylindrical shape tube 38 is encircled and threaded through the hole 10 at the first face of the trunk 14 to reach the second face till the funnel shape head 36 remains out positioned and anchored about a circumference of the hole 10. The funnel shape head 36 remains anchored about the hole 10 when the cylindrical shape tube 38 is completely inserted inside the trunk 14.

According to the embodiment, the cylindrical shape tube 38 and the funnel shape head 36 includes the inner diameter sufficiently larger to enable the cable 12 to enter the tube 30 and prevent the cable 12 movement against the cambium layer, and not to inhibit growth of the tree respectively. The funnel shape tube 30 further includes washers (not shown) extending substantially through the entire length of the tube 30 at regular intervals. Like the barrier ring 29 in FIG. 4, the funnel shape head 36 anchored about the circumference of the hole 10 is capable of preventing a shift in the position of the tube 30 positioned in the hole 10 and controlling depth of insertion of the funnel shape tube 30.

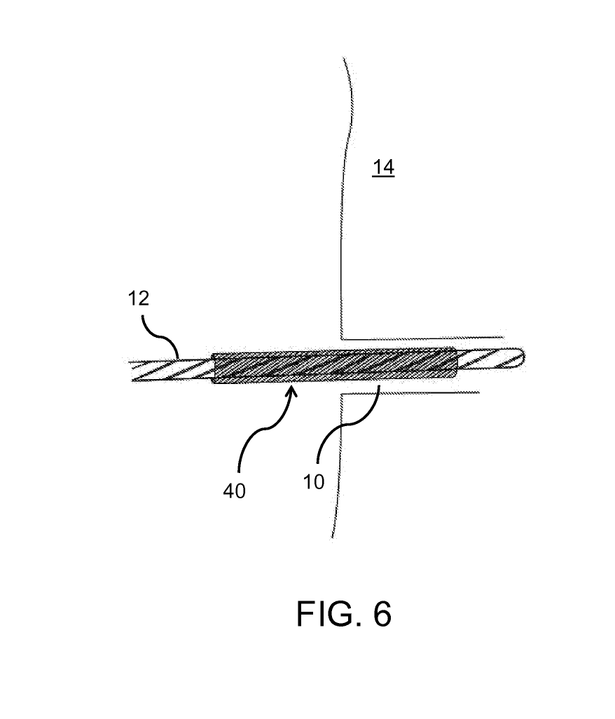

Referring to FIG. 6 illustrates yet another example embodiment of the tree guard according to the present invention. As seen, the guard includes a simple tube 40 without any barrier ring 29 or the funnel shape head 36 as was discussed in embodiments above. This embodiment is not regarded as preferable because the guard 40 herein in this embodiment is unable to control the depth of insertion of the tube 40 onto the trunk 14, and hence can shift in its positions as the cable 12 moves inside the hole 10 thereby causing wound and not allowing the cambium to heal the wound.

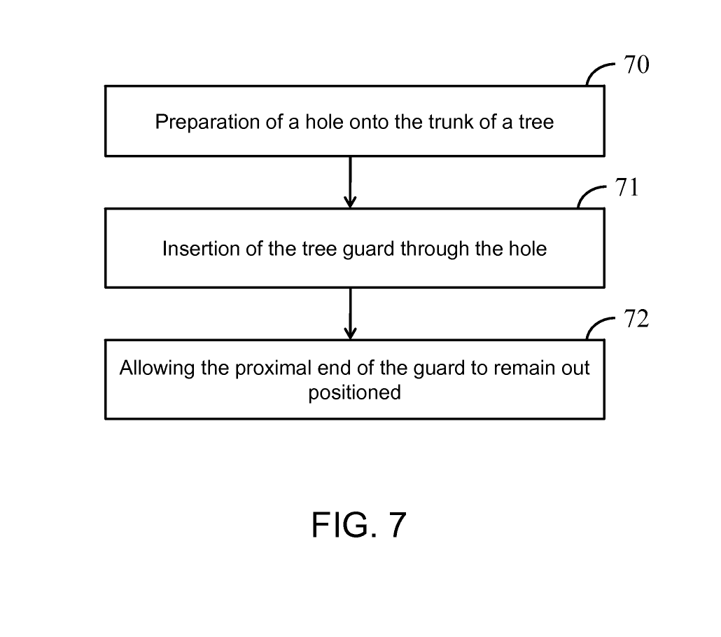

Referring to FIG. 7 is a flow diagram illustrating method for installing the tree guard onto the trunk of the tree according to a preferred embodiment of this present invention. The tree guard comprises the components as described in FIGS. 4 above. The method disclosed herein starts at block 70 which describes about preparation of a hole 10 onto the trunk 14 preferably by drilling. The hole 10 extends from the first face to the second face of the trunk 14 as illustrated in accompanying figures. According to the embodiment, the diameter of the hole 10 drilled is kept sufficiently larger than the diameter of the cable 12 such as to enable the cable 12 to enter the tube 20 easily and prevent the cable to move or rub against the exposed cambium layer. Flow then proceeds to step 71.

The step 71 describes about insertion of the tree guard 20 through the drilled hole 12. The distal end 28 of the tube 20 is encircled and threaded through the hole 10 at the first face to reach the second face where the distal end 28 is anchored using a suitable anchoring means 16. Flow then proceeds to Step 72.

The step 72 describes about allowing the proximal end 26 of the tube 20 to remain out positioned about the circumference of the hole 10 when the barrier ring 29 anchors the tube 20 against the trunk 14. The barrier ring 29 includes an outer diameter sufficiently larger such as not to inhibit the growth of the tree, and control depth of insertion of the tube 20 through the trunk 14.

One or other steps would be present in between or after the steps described above like insertion of cable 12 through the proximal end 26 anchoring the tube 20 against the trunk 14 etc. Those steps are considered to be understood by those skilled in the art and attempt is made to just highlight on the installation of the tree guard of the present invention.

The tree guard of the present invention can be made using several methods readily available using a wider range of materials, particularly but not by limitation stainless steel, aluminum, brass, copper, or any other material that is strong, corrosion-resistant, and is not brittle in characteristics.

It is to be understood, however, that even though numerous characteristics and advantages of the present invention have been set forth in the foregoing description, together with details of the structure and function of the invention, the disclosure is illustrative, and may change in matters of order, size or arrangement of parts which may be made within the principles of the invention and to the full extent indicated by the broad general meaning of the terms in which the appended claims are expressed.

While described above is a description of various embodiments of the present invention, further modifications may be employed without departing from the spirit and scope of the present invention. Thus the scope of the invention should not be limited by the specific structures disclosed. Instead the true scope of the invention should be determined by the following claims.

What is claimed is:

1. A tree guard for protecting cambium beneath the bark layer from mechanical damage caused by a tree support cabling system, said tree guard comprising:
a cylindrical shape tube 20 with a top wall 22 and a bottom wall 24, said tube 20 including a proximal end 26 and a distal end 28 sufficiently differentiated in length by a barrier ring 29 rigidly attached thereto on said top wall 22,
such that the said distal end 28 of said tube 20 be encircled and threaded through a hole 10 at a first face of a trunk 14 to reach a second face of said trunk 14; and
such that the said proximal end 26 of said tube 20 be remain out positioned about a circumference of said hole 10 when said barrier ring 29 anchors said tube 20 against said trunk 14.
wherein said tube 20 having an inner diameter sufficiently larger than a cable diameter enabling said cable 12 to enter said tube 20 and prevent cable movement against the said cambium, and
said barrier ring 29 with an outer diameter sufficiently larger such as not to inhibit growth of the tree.

2. The tree guard of claim 1, wherein said tube 20 further comprising a plurality of washers extending substantially through the entire length of said tube 20 at regular intervals.

3. The tree guard of claim 1, wherein said barrier ring 29 being capable of preventing a shift in the position of said tube 20 positioned in said hole 10.

4. The tree guard of claim 1, wherein said barrier ring 29 further being capable of controlling depth of insertion of said tube 20.

5. The tree guard of claim 1 is further capable of moving the fulcrum of the cable's movement away from the said cambium.

6. A tree guard for protecting cambium beneath the bark layer from mechanical damage caused by a tree support cabling system, said tree guard comprising:
a funnel shape tube 30 with a top wall 32 and a bottom wall 34, said tube 30 including a funnel shape head 36 at first end and a cylindrical shape tube 38 at second end,
said cylindrical shape tube 38 is encircled and threaded through a hole 10 at a first face of a trunk 14 to reach a second face of said trunk 14, and said funnel shape head 36 remains out positioned and anchored about a circumference of said hole 10 when said cylindrical shape tube 38 is completely inserted onto said truck 14 through said hole 10.
wherein said cylindrical shape tube 38 and said funnel shape head 36 having an inner diameter sufficiently larger to enable said cable 12 to enter said tube 30 and prevent the cable movement against the said cambium, and not to inhibit growth of the tree respectively.

7. The tree guard of claim 6, wherein said funnel shape tube 30 further comprising a plurality of washers extending substantially through the entire length at regular intervals.

8. The tree guard of claim 6, wherein said funnel shape head 36 being capable of preventing a shift in the position of said tube positioned in said hole 10.

9. The tree guard of claim 6, wherein said funnel shape head 36 anchored about said circumference of said hole 10 is capable of controlling depth of insertion of said funnel shape tube 30.

10. The tree guard of claim 6 is further capable of moving the fulcrum of the cable's movement away from the said cambium.

11. A method for installing a tree guard onto a trunk of a tree for protecting cambium beneath the bark layer from mechanical damage caused by a tree support cabling system, where said guard including a cylindrical shape tube 20 with a top wall 22 and a bottom wall 24, a proximal end 26 and a distal end 28 sufficiently differentiated in length by a barrier ring 29 rigidly attached thereto on said top wall 22, said method comprising steps of:
preparing, a hole 10 onto said trunk 14, said hole extending from a first face to a second face of the said trunk 14;
encircling and threading, said distal end 28 of said tube 20 through said hole 10 at said first face to reach said second face; and
allowing, said proximal end 26 of said tube 20 to remain out positioned about a circumference of said hole 10 when said barrier ring 29 anchors said tube 20 against said trunk 14.

12. The method of claim 11, wherein said tube 20 having an inner diameter sufficiently larger than a cable diameter to enable said cable 12 to enter said tube 20 and prevent cable movement against the said cambium.

13. The method of claim 11, wherein said barrier ring 29 having an outer diameter sufficiently large such as not to inhibit growth of the tree.

14. The method of claim 11, wherein said tube 20 further comprising a plurality of washers extending substantially through the entire length of said tube 20 at regular intervals.

15. The method of claim 11, wherein said barrier ring being capable of: preventing a shift in the position of said tube positioned in said hole; and controlling depth of insertion of said tube.
